(19) United States
(12) Patent Application Publication
(10) Pub. No.: US 2008/0086543 A1
(43) Pub. Date: Apr. 10, 2008

(54) METHOD AND SYSTEM FOR REVIEWING AND RATING SCRIPTS TO GENERATE A QUANTIFIABLE SCORE

(76) Inventor: Jon R. Carpenter, Los Angeles, CA (US)

Correspondence Address: MORRISS OBRYANT COMPAGNI, P.C., 734 EAST 200 SOUTH, SALT LAKE CITY, UT, 84102, US

(21) Appl. No.: 11/870,147

(22) Filed: Oct. 10, 2007

Related U.S. Application Data
(60) Provisional application No. 60/850,202, filed on Oct. 10, 2006.

(51) Int. Cl. G06F 15/16

(52) U.S. Cl. 709/219

(57) ABSTRACT

The present invention discloses a method and system for reviewing script file(s) to provide a quantified quality score. The system includes a server system, a processing module, and a data storage module. The server system is configured to receive the script files from a writer and assign these script files to multiple readers for analysis. The processing module is operatively coupled to the server system for processing the analyzed script files by the plurality of readers. The processor checks the status of individual reviews of the plurality of readers before generating a final score. The data storage module is operatively coupled to the server system and the processing module for storing the script files and the reviewed script files.

### FIELD OF THE INVENTION

The present invention relates generally to entertainment industries, and more specifically to a system and method for reviewing and rating various kind of scripts to provide a standardized quantifiable score.

### BACKGROUND OF THE INVENTION

In motion picture and television industries, writing a script file is an art and craft for television programs, films or video games. The script file is a blue print for the television programs, films or video games. The script file is written by a screenwriter. An unknown screenwriter has better odds of winning the lottery than getting his or her script file read by someone in the industry, let alone sold. Even for a brilliant screenwriter, the chance of his or her script file getting into the hands of a decision maker at a talent agency, television network, production company or studio, is virtually nil.

People unfamiliar with the entertainment industry are usually surprised when they hear that it is so difficult to get a script considered by the entertainment industry. People will often ask, “Why can't I just send my fantastic script to the studio so they can see how amazing it is?” The short answer is, because no one will even accept it, let alone read it. Agencies, studios, and production companies face their own problems when it comes to reading new material. In many instances, they do not have the resources to hire a myriad of employees to read the hundreds, if not thousands, of script files that would be submitted every month if they had an open-door policy for accepting new script files. It is also the case that studios, production companies, and agencies do not accept unsolicited script files because of the risk of being sued when the unknown author, even erroneously, feels that his or her ideas have been stolen. It is not uncommon for an entertainment entity to be already working on a project that someone else has also thought of. For example, “Dante's Peak” and “Volcano”—two major big-budget movies—each about an exploding volcano, were both released in 1997. Moreover, even if an entity did have the resources to pay readers to read thousands of script files each month, it would be a considerable waste of money since the majority of spec script files are not good enough for commercial use. There are literally tens of thousands of screenplays in existence, but few of them are sufficiently original or of sufficient quality to even be considered by the entertainment industry.

Therefore, there is a need in the art for a method and system for evaluating various kinds of scripts and creating a database of new pre-filtered literary material. Thus, it would be advantageous to provide a system and method for evaluating various types of scripts in order to assign quantifiable quality scores. It would also be an advantage to provide a system and method for standardizing script development for various industries. It would be yet another advantage to enable a writer to make a script file available online to those in the entertainment industry for sorting the script file based on author, rating, genre, length, format, date reviewed and other criteria.

### SUMMARY OF THE INVENTION

To achieve the aforementioned objective, the present invention provides a method for evaluating a script file in which various steps are followed to assign a quantifiable quality score to the script file and to standardize script development. The methods according to the present invention have applicability to any field within the entertainment industry where scripts are prepared and evaluated. Accordingly, one embodiment of a method for developing and assigning a quality score includes uploading a script file onto a server system, assigning the script file to a plurality of readers for analysis and having each of the readers evaluate the script file and assign a rating thereto. The screenwriter can check the status of the individual reader review to determine if the reader has reviewed the script file. The screenwriter can withdraw the script file from a particular reviewer if the review has not been completed by the particular reviewer and assign the script file to another reviewer for completing the review. The individual reader ratings are processed and compiled to generate a final score once the reviews by the plurality of readers have been completed. The script files can then be judged according to the script's final score and selected from a list of script files based upon final scores.

The method for evaluating script files may also include a server system configured to receive script files from a writer and assigning the script files to a plurality of readers for analysis. The system includes a processing module operatively coupled to the server system for processing the reviewed script files received from the script readers and checking status of individual reviews from the script readers before generating a final score. A data storage module is operatively coupled to the server system and the processing module for storing the unread script files and the reviewed script files.

The method for evaluating script files may also include a computer software program for evaluating script files. The computer software program includes a computer readable medium configured with processor executable instructions. The computer software provides the ability to upload a script file onto a server system, assign the script file to a plurality of readers for analysis, allowing the plurality of readers to evaluate the uploaded script file. Allowing the readers to assign an individual rating to the script file. The software also allows the writer to check the status of individual reviews of the plurality of readers and to withdraw a script file from a reader and assign it to another reader for completing the review, if the status of the individual reviews by the any of the plurality of readers is not completed. Once the status of the individual reviews by the plurality of readers is completed, the software processes the plurality of individual ratings and generates a final score. The script file can then be displayed according to its final score and selected therefrom.

### BRIEF DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims and to the several drawings. In the accompanying drawings, like reference numerals are used to indicate like elements.

FIG. 1 is a schematic flow diagram of an environment in which the present invention can be implemented.

FIG. 2 is a schematic flow diagram of an embodiment of a method for evaluating a script file in accordance with the principles of the present invention.

FIG. 3 is a schematic flow diagram of another embodiment of a method for evaluating a script file accordance with the principles of the present invention.

### DETAILED DESCRIPTION OF THE ILLUSTRATED EMBODIMENTS

The present invention relates to systems and methods related to the evaluation of script files. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention. Similarly, while the drawings are depict illustrative embodiments of the systems and methods in accordance with the present invention and illustrate the principles upon which the systems and methods are based, they are only illustrative and any modification of the invented features presented here are to be considered within the scope of this invention.

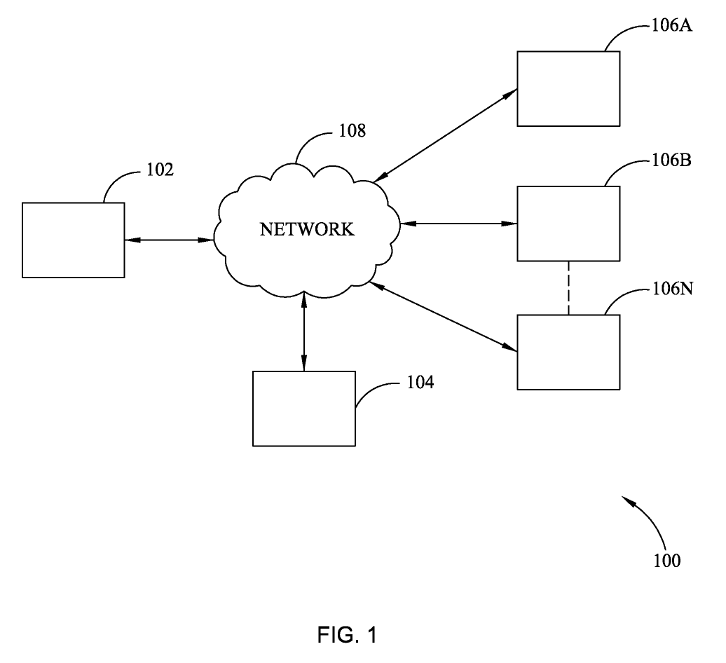

FIG. 1 illustrates a schematic flow diagram of an environment in which the present invention can be implemented. A network system 100 contains a writer system 102, a server system 104, multiple reader systems, such as 106A, 106B . . . 106N, a network 108 which is the medium used to provide communications links between various systems connected together within 100. The network 108 may include connections, such as wire, wireless communication links, or fiber optic cables. In an embodiment of the present invention, the network 108 is a wireless electronic communication network, such as internet and mobile phone networks.

In the depicted example, the writer system 102 is connected to the network 108. In addition, multiple reader systems, such as 106A, 106B, . . . ,106N are connected to network 108. The server system 104 is also connected through the network 108. The writer system 102 and the reader systems, such as 106A, 106B, . . . ,106N may be personal computers or network computers and like. In the depicted examples, the writer system 102 and the reader systems, such as 106A, 106B, . . . ,106N may be located in multiple, geographically distributed sites. The network system 100 can further include some additional systems, and any other devices not shown.

In the depicted examples, the network system 100 is the Internet with the network 108 representing a worldwide collection of networks and gateways that use the TCP/IP suite of protocols or any similar protocols to communicate with one another. The network system 100 can also be implemented as a number of different types of networks, such as for example, an intranet, a local area network (LAN), or a wide area network (WAN).

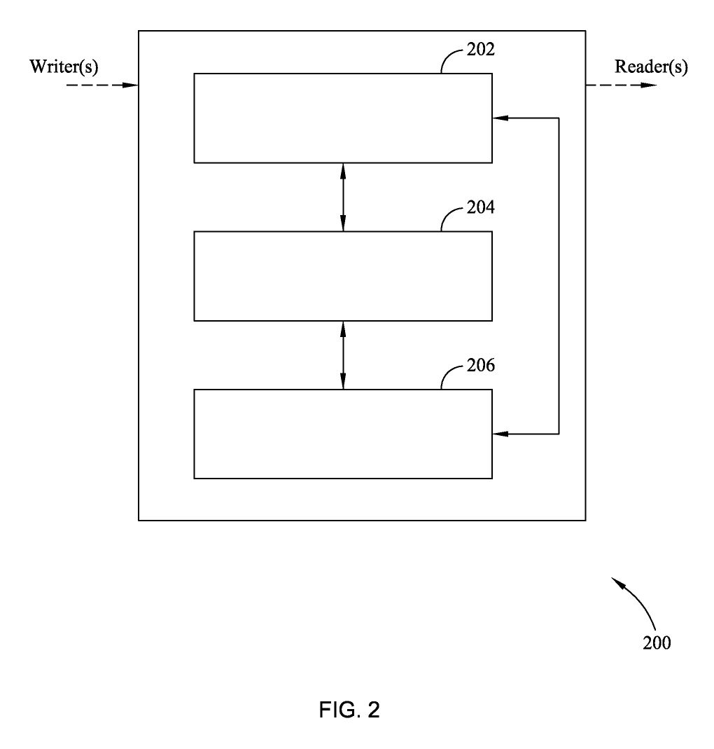

FIG. 2 illustrates a system 200 according to the present invention. The system 200 evaluates at least one script file to provide a standardized quantifiable score. The system 200 includes a server system 202, a processing module 204, and a data storage module 206. The server system 202 is configured to receive at least one script file from a writer and assign these script files to multiple readers for analysis. The processor module 204 checks the complete status of individual reviews by multiple readers before generating a final score. If the status of the individual reviews is incomplete, then the processor withdraws that particular script file from that reader to assign this script file to another reader for completing it. Finally, the processing module 204 processes the reviewed script files received after analysis from these multiple readers to generate a final score. The data storage module 206 is operatively coupled to the server system 202 and the processing module 204 for storing the original script files and the reviewed script files for further usage.

The system 200 enables the readers to input their reviews online. Additionally, the system 200 includes a payment module for authenticating and distributing fees to the multiple readers. The payment module enables the system 200 to accept payments from the writer and facilitates to directly deposit the payments into a bank account.

The present invention provides a method by which the writer of film and television program scripts can get their script file(s) evaluated and scored, providing the writer with credibility before trying to sell the script files, and providing the entertainment industry a method to standardize the scripts development. The method starts with a writer completing an online application, and uploading the script files online, via the Internet or any other means along with their payment through customized website to a server system. In an embodiment, a file format sent through a computer can be a PDF, or a specialized scriptwriting software Final Draft format or any other available format. The method enables the writer to submit fees during uploading of these script files. The method provides sending automated notifications to subscribers regarding a new high-rated script. As part of the application and uploading processes, the writer submitting script files will digitally sign a waiver, waiving their right to sue any client companies that receive their script files. Additionally, the method will provide indemnity insurance for clients who read the script files, to give them the added security of knowing they can look at new projects with little to no risk.

In the illustrated embodiment, the system 200 will assigns and electronically sends each script file to a plurality of readers via a secure online connection to the reader's computer. The readers do not have access to each other. In the present case, the plurality of readers comprises three different readers. Each reader will complete a two to three page critique online, and bestow one of the three standard industry ratings: “pass,” (i.e. reject), “consider,” or “recommend.” Each individual rating from each reader is assigned a numerical score; 1 for “pass,” 2 for “consider,” and 3 for “recommend,” which will then be added together to get the script's final score. In case the script file has not completed the review within a predetermined time period then the script file is rescinded and assigned to another reader.

In one embodiment of the present invention, the script is reviewed by multiple readers to generate an appropriate score. In film industries, top-level executives have missed great opportunities by rejecting projects which turned out to be blockbusters at another company. It is often said that “one person's trash is another person's treasure,” and the same holds true for television and film. This method will mitigate this type of mistake by having three different story readers (analysts) cover the same script file, each providing a unique and separate review.

In another embodiment of the present invention, the script file is reviewed by multiple readers who are bound by a strict Non-Disclosure Agreement (NDA) which prohibits these readers from discussing any of the script files with another party, even if that other party is also a contracting party to the system. The readers will be working independently which also significantly reduces the likelihood that they will discuss the script file(s) with other readers who are providing coverage for the same script file(s). Generally, the readers would not even know each other. This will better ensure that the reviews are not tainted by the opinions of others.

In yet another embodiment, the writer's name is omitted from the script file(s) to avoid prejudgment of the script. The system and method provides tracking the script files by number (which the online system will assign randomly), rather than by the writer's name, so readers cannot prejudge the script file from the writer's name. Prejudging the script file based on the writer's name may sound ridiculous, but can and does often bias script reviews. No matter how culturally savvy readers may think they are, allowing them to see the writer's name increases whatever slight tendency there might be to prejudge the script file. Therefore, by omitting the writer's name, the system and method will avoid a major source of pre-judging and pre-biasing.

In yet another embodiment, a title of the script file is omitted to avoid prejudgment of the script file. The script files will be tracked solely by number so the reader does not prejudge the script from a subjective good or bad title. The reader will know what genre the writer believes it to be prior to read it, so readers will not go into the review completely blind. But this method is as objective as possible.

In yet another embodiment, one script file is assigned to different script readers with unique script numbers. Every reader will have a different tracking number for the same script file (assigned and coordinated by the present invention's online computer system 200), to prevent readers from attempting to collude. Thus, the reader cannot easily reference a project by a common number.

In yet another embodiment, the script files are assigned based on reader's preferred genres. To keep the coverage objective, the method will collect preferences from readers, and match readers with script files from the genres they enjoy, and can better evaluate. Some readers may really dislike westerns, while others might find musicals trite. If a reader receives the script files that do not fall into a genre then the reader would not care for the script files. Hence, the script files do not have a chance for a truly fair assessment even though it may very well be amazing. The script files will be evaluated by readers best qualified to appreciate that genre.

In yet another embodiment, an online statistical tracking is provided to ensure accuracy and consistency. The system 200 will track and evaluate the reader's performance statistics. For example, the method will provide an alert if one reader is recommending scripts at a greater percentage while another reader is being too strict and rejecting scripts at a greater percentage. Or if one reader is recommending all of one genre while passing others. To ensure accuracy and consistency, this methodology will use every statistical tool available to that end.

In yet another embodiment, a script file receiving two or more “recommends” will then be reviewed by a reader manager to confirm that the first three reviews are fair and proper, before the script file is made available to the industry online. If the fourth reader confirms the prior recommendations, the script file is given an additional point. As such, a poor script will receive a total score of 3 (3 readers times 1 point each) and a perfect script will receive a 10 (3 readers times 3 points each, plus 1 for confirmation).

Further, the system 200 allows online users to sort the script files according to various categories, such as author, genre (and sub-genre), rating, length, format (film/T.V.), date reviewed, location of author, availability for immediate option or purchase, projected budget range, number of actors, age of actors, locations involved, time period (e.g. wild west, renaissance, biblical, etc.) special effects, prior options/sales made, use of animals type of seasons or weather, or talent already attached to the project. The system 200 allows entities to subsidize the fees for reviewing script files (e.g. screenwriting competitions, film school admissions, diversity programs, etc.). The system 200 also allows discount codes to reduce the amount of the fee. The system 200 compiles and reports statistical data on performance of readers. The system 200 compiles and reports statistical data on sales and options. The system 200 compiles and reports statistical data to on online users. The system 200 sends automated emails to subscribers regarding new highly rated scripts. The system 200 sends automated emails to press and publicity outlets (at predetermined intervals) about options and sales (if requested by both writer and buyer).

The major agencies, studios, networks, etc. will be given pass-codes to the website to browse the reviewed scripts. At the time the writers upload their script files for review, writers will have the opportunity to also make their script files available for an immediate sale or option at a predetermined price (or best offer by the end of a time frame). If the writer has made that option available, a potential buyer can use the online system to complete that transaction and the buyer can electronically receive the script files. This business method will revolutionize the way entertainment script development operates. Agents, executives, and producers will no longer have to spend their evenings and weekends, or use their assistants' time, to find out if a script is worth buying. They will have a new and enormous pool of pre-filtered material to draw from, without any major expenses or liability. And it will finally give unknown writers real access to Hollywood.

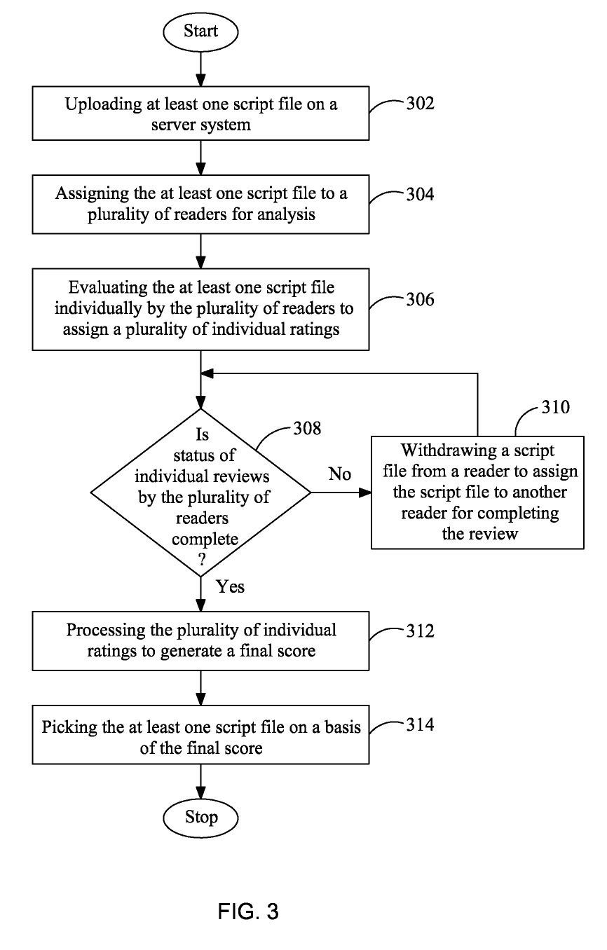

FIG. 3 illustrates is a schematic flow diagram of a method for evaluating at least one script file according to the present invention. The method includes at step 302, the at least one script file is uploaded on a server system. At step 304, the at least one script file is assigned to a plurality of readers for analysis. At step 306, the at least one script file is evaluated individually by the plurality of readers to assign a plurality of individual ratings. At step 308, status of individual reviews of the plurality of readers is checked. At step 310, a script file is withdrawn from a reader to assign the script file to another reader for completing the review, if the status of the individual reviews by the plurality of readers is not completed. At step 312, the plurality of individual ratings is processed to generate a final score, if the status of the individual reviews by the plurality of readers is completed. At step 314, the at least one script file is picked on a basis of the final score.

The present invention offers several advantages. First, the present invention provides a system and method by which scripts written for television programs, films or video games are screened and evaluated. Second, the present invention standardizes script development for television programs, films or video games. Third, the present invention facilitates writers to make a script file available online to those in the entertainment industry and for sorting the script file based on author, rating, genre, length, format, date reviewed and other criteria.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains. The description of the present invention has been presented for purposes of illustration and description, and is not intended to be exhaustive or limited to the invention in the form disclosed. Many modifications and variations will be apparent to those of ordinary skill in the art. Although the depicted illustrations show the method of the present invention embodied on a single server, this method may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for evaluating script files comprising:
uploading at least one script file on a server system;
assigning the at least one script file to a plurality of readers for analysis;
evaluating the at least one script file by the plurality of readers;
assigning an individual rating to the at least one script by each of the plurality of readers;
checking the status of the individual reviews of the at least one script;
withdrawing a script file from an individual reader of the plurality of readers and assigning the script file to another individual reader for completing the review, if the status of an individual review by at least one of the plurality of readers is not completed;
processing the plurality of individual ratings to generate a final score, once the status of the individual reviews by the plurality of readers is completed; and
selecting the at least one script file on a basis of a final score, the final score being compiled from ratings of the individual reviews.

2. The method of claim 1, further comprising submitting fees during uploading the at least one script file.

3. The method of claim 1, further comprising sending automated notifications to subscribers regarding a new high-rated script.

4. A system for evaluating a script file, comprising:
a server system configured to receive the at least one script file from a writer and assigning the at least one script file to a plurality of readers for analysis;
a processing module operatively coupled to the server system for processing the at least one script file and reviews of the at least one script file that have been received from the plurality of readers and for checking a status of individual reviews by the plurality of readers before generating a final score; and
a data storage module operatively coupled to the server system and the processing module for storing the at least one script file and the reviews of the at least one script file.

5. The system of claim 4, further comprising a payment module for authenticating and distributing fees to the plurality of readers.

6. A computer program for evaluating at least one script file, comprising:
allowing the uploading of at least one script file on a server system;
assigning the at least one script file to a plurality of readers for analysis;
allowing the plurality of readers to evaluate the at least one script file on an individual basis;
allowing the plurality of readers to each assign the at least one script file a rating;
allowing a writer of the at least one script file to check a status of reviews of the plurality of readers;
allowing the writer to withdraw the at least one script file from at least one of the plurality of readers and to assign the at least one script file to another reader for completing the review, if the status of any of the individual reviews by the plurality of readers has not been completed;
processing each rating from the plurality of readers of the at least one script file and generating a final score, if the status of the individual reviews by the plurality of readers is completed; and
allowing the selection of the at least one script file on a basis of the final score.
